(19) United States
(12) Patent Application Publication
(10) Pub. No.: US 2009/0191108 A1
(43) Pub. Date: Jul. 30, 2009

(54) Zirconium/Praseodymium Oxide NOx Traps and Prufication of Gases Containing Nitrogen Oxides (NOx) Therewith

(75) Inventors: Gilbert Blanchard, Lagny-Le-Sec (FR); Emmanuel Rohart, Sainte Soulle (FR); Yvane Lendresse, Rueil-Malmaison (FR); Frederic Tronel, Asnieres (FR); Xavier Courtois, La Chapelle Mouliere (FR); Daniel Duprez, Poitiers (FR); Sanaa Elbouazzoui, Rabat (MA); Patrice Marecot, Saint-Georges-Les-Billargeaux (FR)

Correspondence Address: BUCHANAN, INGERSOLL & ROONEY PC, POST OFFICE BOX 1404, ALEXANDRIA, VA, 22313-1404, US

(73) Assignees: RHODIA RECHERCHES ET TECHNOLOGIES, Aubervilliers (FR); CENTRE NATIONAL DE LA RECHERCHE SCIENTIFIQUE, Paris Cedex 16 (FR); PEUGEOT CITROEN AUTOMOBILES SA, Velizy (FR); L'UNIVERSITE DE POITIERS, Poitiers Cedex (FR)

(21) Appl. No.: 11/991,856

(22) PCT Filed: Sep. 8, 2006
(86) PCT No.: PCT/FR2006/002069

§ 371 Date: Feb. 26, 2009

(30) Foreign Application Priority Data
Sep. 12, 2005 (FR) 05 09275

(51) Int. Cl. B01D 53/56; B01J 23/10; B01J 19/00; F01N 3/20

(52) U.S. Cl. 423/239.1; 502/302; 422/168; 60/299

(57) ABSTRACT

A method for treating/purification a gas containing nitrogen oxides (NOx) includes conveying same through a NOx trap containing a composition based on a catalyst for oxidizing NOx into NO₂ and a compound based on zirconium oxide and praseodymium oxide in a proportion of praseodymium oxide ranging from 5 wt. % to 50 wt. % of oxide; such compound may further include cerium oxide and the subject process is useful for treating the exhaust gas of a Diesel or lean mixture gasoline internal combustion engine.

The present invention relates to a process for the treatment of a gas comprising nitrogen oxides (NOx) using, as NOx trap, a composition based on zirconium oxide and praseodymium oxide.

It is known that environmental standards are making it increasingly essential to reduce emissions of nitrogen oxides (NOx) from the exhaust gases of motor vehicle engines and in particular diesel engines or gasoline engines operating under lean burn conditions, engines for which “triple way” catalysts are unsuitable.

Systems known as NOx traps have been proposed as type of catalysts capable of meeting this need. They are systems capable of partially oxidizing and then storing the nitrogen oxides present in a lean gas and then of releasing the same oxides and reducing them to nitrogen when the surrounding mixture is rich.

However, the known NOx traps still have a number of disadvantages. Thus, their capacity to trap or store NOx is optimum at high temperatures, that is to say generally of the order of 400° C., and thus they exhibit low efficiency at lower temperatures. Furthermore, these traps are sensitive to sulfation and it is possible to regenerate them only in part except only by carrying out the regeneration treatment at high temperature, for example at least 650° C.

There is consequently a need for NOx traps not exhibiting these disadvantages.

A subject-matter of the invention is thus the development of an NOx trap which is effective within a region of low temperatures of less than 400° C. Another subject-matter of the invention is the provision of an NOx trap which, after sulfation, can be regenerated or desulfated more easily, in particular at temperatures below 600° C.

With this aim, the invention relates to a process for the treatment of a gas comprising nitrogen oxides (NOx) which is characterized in that use is made, as NOx trap, of a composition based on a catalyst for the oxidation of NOx to NO₂ and on a compound based on zirconium oxide and praseodymium oxide in a proportion of praseodymium oxide of between 5% and 50% by weight of oxide.

The NOx trap used in the process of the invention can be effective within a range of temperatures extending from 200° C. to 300° C., for example. This NOx trap can furthermore be largely regenerated at a temperature which can be as low as approximately 550° C.

Other characteristics, details and advantages of the invention will become even more fully apparent on reading the description which will follow and also the various concrete but nonlimiting examples intended to illustrate it.

It is specified for the continuation of the description that, unless otherwise indicated, within the ranges of values which are given, the values at the limits are included.

The term “nitrogen oxide NOx” is understood to mean in particular oxides of the protoxide N₂O, sesquioxide N₂O₃, pentoxide N₂O₅, monoxide NO and dioxide NO₂ type.

The term “specific surface” is understood to mean the BET specific surface determined by nitrogen adsorption in accordance with standard ASTM D 3663-78 based on the Brunauer-Emmet-Teller method described in the periodical “The Journal of the American Chemical Society, 60, 309 (1938)”.

The process of the invention is characterized by the use, as NOx trap, of a specific composition which will be described more specifically below.

This NOx trap is a composition which comprises first of all a catalyst for the oxidation of NOx to NO₂. Catalysts of this type are known. They are generally metals and mention may more particularly be made, as catalysts of this type, of precious metals. This term is understood to mean gold, silver and metals of the platinum group, that is to say ruthenium, rhodium, palladium, osmium, iridium and platinum. These metals can be used alone or in combination. Platinum can be used very particularly, alone or in combination with in particular rhodium and/or palladium and, in the case of a combination, in predominant proportion with respect to the other metal or other metals.

The amount of oxidation catalyst, for example a precious metal, can be, for example, between 0.05% and 10%, preferably between 0.1% and 5%, this amount being expressed as weight of the oxidation catalyst in the metallic form with respect to the weight of the whole of the NOx trap (catalyst+compound based on zirconium oxide and praseodymium oxide).

In addition to the oxidation catalyst, the NOx trap of the invention comprises, as support for this catalyst, a compound which is based on zirconium oxide and praseodymium oxide. As indicated above, the proportion of praseodymium oxide in the compound is between 5% and 50%, it being understood that it is a proportion expressed as weight of praseodymium oxide Pr₆O₁₁ with respect to the whole weight as oxide of the compound. Below 5%, the content of praseodymium oxide is too low to observe a meaningful effect of NOx trap. Above 50%, the thermal stability of the compound, that is to say the value of its specific surface at the temperatures at which it is used, becomes inadequate.

The content of praseodymium oxide, expressed as indicated above, can more particularly be between 10% and 40%.

According to an alternative form of the invention, the compound based on zirconium oxide and praseodymium oxide can additionally comprise cerium oxide, in particular CeO₂. In this case, the proportion of cerium oxide can be such that the Ce/Zr atomic ratio is between 10/90 and 90/10. More particularly, this ratio can be at least 1.

Compounds based on zirconium oxide and praseodymium oxide are known. They are described in particular in FR-A1-2 590 887, which reports a composition based on zirconium oxide and on an additive which can in particular be praseodymium.

Thus, these compounds can be prepared by precipitation processes. Mention may in particular be made, in this case, of a preparation by precipitation by addition of a basic compound, such as aqueous ammonia, to a solution of an acidic precursor of the zirconium, for example a zirconium nitrate, chloride or sulfate, and of a praseodymium salt, such as a nitrate, a chloride, a sulfate or a carbonate. Another process which can be used consists in mixing a praseodymium salt with a zirconium hydrate sol; the suspension thus obtained is subsequently dried. It is also possible to impregnate zirconium oxide using a solution of a praseodymium salt.

Another more specific process for the preparation of compounds based on zirconium oxide and praseodymium oxide will be described below. This process makes it possible to obtain specific compounds, the specific surface of which is particularly high and stable.

Thus, this surface is at least 29 m²/g, after calcining at 1000° C. for 10 hours. At lower temperatures than those which have been mentioned above, for example after calcining at 900° C. for 4 hours, these specific compounds can exhibit a specific surface of at least 45 m²/g.

These compounds can be provided in some cases in the form of solid solutions of the praseodymium in the zirconium oxide.

Furthermore, these compounds exhibit a specific porosity. This is because they comprise mesopores, that is to say pores having a size of between 10 nm and 500 nm, this being the case even after calcining at high temperature. These size values are obtained by mercury porosimetry (analysis carried out with an Autopore 9410 porosimeter from Micromeritics comprising two low pressure stations and a high pressure station). These mesopores can contribute to a large part of the total pore volume; for example, they can introduce at least 30%, more particularly at least 40%, of the total pore volume.

The process for producing these specific compounds which have just been described comprises the following stages:
(a) a mixture is formed comprising zirconium and praseodymium compounds;
(b) said mixture and a basic compound are brought together, whereby a precipitate is obtained;
(c) said precipitate is heated in a liquid medium;
(d) a compound chosen from anionic surfactants, nonionic surfactants, polyethylene glycols, carboxylic acids and their salts, and surfactants of the carboxymethylated fatty alcohol ethoxylates type is added to the precipitate obtained in the preceding stage;
(e) the precipitate thus obtained is calcined.

The first stage of the process thus consists in preparing a mixture in a liquid medium of a zirconium compound and of a praseodymium compound.

The mixture is generally prepared in a liquid medium which is preferably water.

The compounds are preferably soluble compounds. These can in particular be zirconium and praseodymium salts.

These compounds can be chosen, for example, from nitrates, acetates or chlorides.

Mention may thus be made, as examples, of zirconyl nitrate or zirconyl chloride. Zirconyl nitrate is most generally used.

It is also possible to use a sol as starting zirconium compound. The term “sol” denotes any system composed of fine solid particles of colloidal dimensions, that is to say dimensions of between approximately 1 nm and approximately 500 nm, based on a zirconium compound, this compound generally being a zirconium oxide and/or a zirconium oxide hydrate, in suspension in an aqueous liquid phase, it being possible in addition for said particles optionally to comprise residual amounts of bonded or adsorbed ions, such as, for example, nitrates, acetates, chlorides or ammoniums. It should be noted that, in such a sol, the zirconium may occur either completely in the form of colloids or simultaneously in the form of ions and in the form of colloids.

The starting mixture can be obtained without distinction either from compounds initially in the solid state which will subsequently be introduced into an aqueous vessel heel, for example, or also directly from solutions of these compounds and then mixing said solutions in any order.

In the second stage (b) of the process, said mixture and a basic compound are brought together. Use may be made, as base or basic compound, of products of the hydroxide type. Mention may be made of alkali metal or alkaline earth metal hydroxides. Use may also be made of secondary, tertiary or quaternary amines. However, amines and aqueous ammonia may be preferred insofar as they reduce the risks of pollution by alkali metal or alkaline earth metal cations. Mention may also be made of urea.

The basic compound is generally used in the form of an aqueous solution.

The way in which the mixture and the solution are brought together, that is to say the order of introduction of these, is not critical. However, this operation of bringing together can be carried out by introducing the mixture into the solution of the basic compound.

The operation of bringing together or the reaction between the mixture and the solution, in particular the addition of the mixture to the solution of the basic compound, can be carried out all at once, gradually or continuously, and it is preferably carried out with stirring. It is preferably carried out at ambient temperature (20-25° C.).

The following stage (c) of the process is the stage of heating the precipitate in a liquid medium.

This heating can be carried out directly on the reaction medium obtained after reaction with the basic compound or on a suspension obtained after separation of the precipitate from the reaction medium, optional washing and putting the precipitate back into water. The temperature at which the medium is heated is at least 100° C. and more particularly still at least 130° C. The heating operation can be carried out by introducing the liquid medium into a closed chamber (closed reactor of the autoclave type). Under the temperature conditions given above, and in an aqueous medium, it may be specified, by way of illustration, that the pressure in the closed reactor can vary between a value of greater than 1 bar (10⁵ Pa) and 165 bar (1.65×10⁷ Pa), preferably between 5 bar (5×10⁵ Pa) and 165 bar (1.65×10⁷ Pa). It is also possible to carry out the heating in an open reactor for temperatures in the vicinity of 100° C.

The heating can be carried out either under air or under an inert gas atmosphere, preferably nitrogen in the latter case.

The duration of the heating can vary within wide limits, for example between 1 and 48 hours, preferably between 2 and 24 hours. Likewise, the rise in temperature is carried out at a rate which is not critical and it is thus possible to achieve the set reaction temperature by heating the medium, for example, between 30 minutes and 4 hours, these values being given entirely by way of indication.

It is possible to carry out several heating operations. Thus, the precipitate obtained after the heating stage and optionally a washing can be resuspended in water and then another heating of the medium thus obtained can be carried out. This other heating is carried out under the same conditions as those which were described for the first.

The following stage (d) of the process consists in adding, to the precipitate resulting from the preceding stage, a compound which is chosen from anionic surfactants, nonionic surfactants, polyethylene glycols, carboxylic acids and their salts, and surfactants of the carboxymethylated fatty alcohol ethoxylates type.

As regards this compound, reference may be made to the teaching of application Wo 98/45212 and use may be made of the surfactants described in this document.

Mention may in particular be made of the products sold under the Igepal®, Dowanol®, Rhodamox® and Alkamide® brands.

The surfactant can be added in two ways. It can be added directly to the precipitate suspension resulting from the preceding heating stage (c). It can also be added to the solid precipitate after separation of the latter by any known means from the medium in which the heating had taken place.

The amount of surfactant used, expressed as percentage by weight of surfactant with respect to the weight of the compound, calculated in oxide, is generally between 5% and 100%, more particularly between 15% and 60%.

In the case of the addition of the surfactant to the precipitate suspension, it is possible, after separating the precipitate from the liquid medium, to wash the precipitate thus obtained.

In a final stage of the process according to the invention, the precipitate recovered is subsequently calcined. This calcination makes it possible to develop the crystallinity of the product formed and it can also be adjusted and/or chosen according to the subsequent operating temperature intended for the compound, this being the case while taking into account the fact that the specific surface of the product decreases as the calcination temperature employed increases. Such a calcination is generally carried out under air but a calcination carried out, for example, under an inert gas or under a controlled atmosphere (oxidizing or reducing) is very clearly not excluded.

In practice, the calcination temperature is generally limited to a range of values of between 500° C. and 1100° C., more particularly between 600° C. and 900° C.

As regards the compounds based on zirconium oxide, praseodymium oxide and cerium oxide, they are also known compounds which are described in particular in patent applications EP-A1-863 846 or EP-A1-906 244, to the teaching of which reference may be made.

Thus, EP-A1-863 846 describes a process for the preparation of compounds of this type in which a mixture comprising a zirconium compound and a cerium(IV) compound is prepared in a liquid medium; this mixture is heated to a temperature of greater than 100° C.; the reaction medium obtained on conclusion of the heating is brought to a basic pH; the precipitate thus obtained is recovered; and said precipitate is calcined; the praseodymium being added either to the starting mixture in a liquid medium or to the reaction mixture obtained on conclusion of the heating. According to another alternative processing form described in the same document, a mixture comprising a cerium compound and at least one zirconium oxychloride and a praseodymium compound is prepared in a liquid medium; said mixture and a basic compound are brought together, whereby the mixture is precipitated; the precipitate thus obtained is recovered; said precipitate is calcined.

EP-A1-906 244 moreover describes a process in which a mixture comprising a cerium compound, a zirconium compound and a praseodymium compound is prepared in a liquid medium; said mixture is heated; the precipitate obtained is recovered and this precipitate is calcined, the abovementioned mixture being prepared by using a zirconium solution which is such that the amount of base necessary in order to achieve the equivalent point during an acid/base titration of this solution obeys the condition OH⁻/Zr molar ratio≦1.65.

The oxidation catalyst of the type described above can be introduced into the composition of the invention by any known method, for example by impregnation of the compound based on oxides with an aqueous solution comprising the precursor of the said catalyst, such as a platinum amine complex.

The gases capable of being treated by the present invention are, for example, those resulting from gas turbines, thermal power station boilers or internal combustion engines. In the latter case, they can in particular be diesel engines or gasoline engines operating under lean burn conditions.

The composition used in the process of the invention operates as an NOx trap when it is brought into contact with gases exhibiting a high oxygen content. The term “gases exhibiting a high oxygen content” is understood to mean gases exhibiting an excess of oxygen with respect to the amount necessary for the stoichiometric combustion of fuels and more specifically gases exhibiting an excess of oxygen with respect to the stoichiometric value λ=1. The value λ is correlated with the air/fuel ratio in a way known per se, in particular in the field of internal combustion engines. Such gases are those from engines operating under lean burn conditions and which exhibit an oxygen content (expressed by volume) of at least 2%, and also those which exhibit an even higher oxygen content, for example gases from engines of the diesel type, that is to say of at least 5% or of more than 5%, more particularly of at least 10%, it being possible for this content to lie, for example, between 5 and 20%.

During the implementation of the process of the invention and very particularly in the case of the treatment of exhaust gases, the NOx trap may become sulfated due to the presence of sulfur in the fuels used for the operation of the engine. Consequently, the trap has to be periodically desulfated. This desulfation is carried out in a way known to a person skilled in the art by raising the temperature of the gases to be treated and by modifying the richness of these gases above the richness 1 (stoichiometry). However, in the case of the present invention, this temperature can be lower than those generally used. For example, it is possible to obtain, on conclusion of a treatment at 550° C., removal of at least 50% of the sulfur adsorbed by the trap. Due to this ease of being desulfated, the compositions of the invention can be used in processes for the treatment of gases resulting from the combustion of fuels with a high sulfur content, for example of at least 350 ppm, more particularly of at least 500 ppm, fuels of the type of those used, for example, in thermal power station boilers.

For the implementation of the process, the composition constituting the NOx trap can be used in the powder form but it can optionally be shaped in order to be provided in the form of granules, beads, cylinders or honeycombs of variable dimensions.

In the implementation of the process of the invention, the composition used as NOx trap can be combined with additional decontaminating systems, such as three-way catalysts, which are effective when the value of λ is less than or equal to 1 in the gases, or also with systems comprising the injection of hydrocarbons or comprising the recycling of the exhaust gases (EGR system) for diesel engines.

This composition can also be used in a device comprising a coating (wash coat) based on the composition on a substrate of the, for example, metal or ceramic monolith type.

The invention thus also relates to a device for the implementation of the process as has been described above and which is characterized in that it comprises, as NOx trap, the composition which has been described above and based on a precious metal and on a compound based on zirconium oxide and praseodymium oxide. This device can be an exhaust line fitted to a motor vehicle comprising a diesel engine or lean burn gasoline engine and which includes a catalytic component which comprises this composition.

Examples will now be given.

### EXAMPLE 1

This example relates to the preparation of a first compound which can participate in a composition which can be used in the process of the invention. This compound is based on cerium oxide, zirconium oxide and praseodymium oxide in the respective proportions, as weight of oxide, of 55%, 15% and 30%.

A ceric nitrate solution, a praseodymium nitrate solution and a zirconium nitrate solution are mixed in the stoichiometric proportions required in order to obtain the above mixed oxide. This zirconium solution was obtained via attack on a zirconium carbonate using concentrated nitric acid. This solution is such that the amount of base necessary in order to reach the equivalent point during an acid/base titration of this solution obeys the condition OH⁻/Zr molar ratio=1.14.

The acid/base titration is carried out in a known way. In order for it to be carried out under optimum conditions, a solution which has been brought to a concentration of approximately 3×10⁻² mol per liter, expressed as elemental zirconium, can be titrated. A 1N sodium hydroxide solution is added thereto with stirring. Under these conditions, the equivalent point (change in the pH of the solution) is determined in a clear-cut way. This equivalent point is expressed by the OH⁻/Zr molar ratio.

The concentration of this mixture (expressed as oxide of the various elements) is adjusted to 80 g/l. This mixture is subsequently brought to 100° C. for 4 hours.

An aqueous ammonia solution is subsequently added to the reaction medium so that the pH is greater than 8.5. The reaction medium thus obtained is brought to reflux for 2 hours. After separating by settling and then withdrawing, the solid product is resuspended and the medium thus obtained is treated at 100° C. for 1 hour. The product is subsequently filtered off and then calcined at 800° C. under air for 4 hours. The product thus obtained exhibits a specific surface of 45 m²/g.

### EXAMPLE 2

This example relates to the preparation of a second compound which can participate in a composition which can be used in the process of the invention. This compound is based on 60% zirconium and 40% praseodymium, these proportions being expressed as percentages by weight of the oxides ZrO₂ and Pr₆O₁₁.

500 ml of zirconium nitrate (120 g/l) and 80 ml of praseodymium nitrate (500 g/l) are introduced into a stirred beaker. The volume is subsequently made up with distilled water so as to obtain 1 liter of a solution of nitrates.

224 ml of an aqueous ammonia solution (12 mol/l) are introduced into a stirred reactor and the volume is subsequently made up with distilled water so as to obtain a total volume of 1 liter.

The solution of nitrates is introduced into the reactor over one hour with constant stirring.

The solution obtained is placed in a stainless steel autoclave equipped with a stirrer. The temperature of the medium is brought to 150° C. for 2 hours with stirring.

The suspension thus obtained is then filtered through a Büchner funnel. A precipitate comprising 19% by weight of oxide is recovered.

100 g of this precipitate are withdrawn.

At the same time, an ammonium laurate gel was prepared under the following conditions: 250 g of lauric acid are introduced into 135 ml of aqueous ammonia (12 mol/l) and 500 ml of distilled water, and then the mixture is homogenized using a spatula.

22.7 g of this gel are added to 100 g of the precipitate and then the combined product is kneaded until a homogeneous paste is obtained.

The product obtained is subsequently brought to 860° C. for 2 hours under stationary conditions. It then exhibits a specific surface of 61 m²/g.

### EXAMPLE 3

This example relates to the preparation of a third compound which can participate in a composition which can be used in the process of the invention. This compound is based on 90% zirconium and 10% praseodymium, these proportions being expressed as percentages by weight of the oxides ZrO₂ and Pr₆O₁₁.

The procedure is carried out in the same way as in example 2, the solutions of nitrates being mixed in the stoichiometric proportions required in order to obtain the above mixed oxide. The specific surface after calcination is 70 m²/g.

### COMPARATIVE EXAMPLE 4

This example relates to the preparation of a compound based on alumina and barium at 10% by weight.

5 g of Puralox alumina are introduced into a beaker and then covered with water (20 ml) before addition of the barium nitrate solution (10 ml at 50 g/l). The solution is evaporated on a sand bath while continuing to stir. After drying overnight at 120° C., the solid is calcined at 700° C. for 4 hours under a 10% O₂/10% H₂O/N₂ mixture. At the end of this treatment, the specific surface of the compound is 89 m²/g.

### EXAMPLE 5

This example gives the results of the measurement of the NOx storage capacity for catalytic compositions comprising 1% platinum prepared from the compounds of the preceding examples and in the following way.

5 g of compound according to one of the above examples are introduced into a beaker and then covered with acetone (20 ml) before the addition of platinum acetylacetonate dissolved in acetone (10 ml at 5 g/l). After evaporating on a sand bath, the catalytic composition thus obtained is dried overnight in an oven at 120° C., then calcined at 500° C. under air for 4 hours and aged at 700° C. under a 10% O₂/10% H₂O/N₂ mixture for 4 hours.

The NOx storage capacity is measured under the following conditions:
the catalytic composition as prepared above is introduced into a reactor and is then pretreated under an oxidizing stream, 10% O₂+5% H₂O in nitrogen, for 30 minutes at a temperature of 200° C.; subsequently, the reactor is isolated,
the reaction stream is subsequently introduced into the catalytic test. The composition of the reaction stream is: 10% O₂+5% H₂O+600 ppm NO in nitrogen,
the NO+NO₂ composition of the reaction mixture is continuously analyzed by chemiluminescence with a Cosma Topaze 2020 analyzer,
after stabilization of the NO+NO₂ analysis, the reaction stream is introduced into the catalytic reactor,
the NO+NO₂ composition at the outlet of the reactor is continuously determined by chemiluminescence,
the integration of the NO+NO₂ content for the 100 seconds which followed the arrival of the reaction stream over the catalytic composition makes it possible to calculate the amount of NOx stored by this composition. The results are expressed by the amount of NOx stored at 200° C. in μmol per gram of catalytic composition,
the measurements are subsequently carried out on other samples of catalytic compositions at temperatures of 300° C., 350° C. and 400° C.

The amounts of stored NOx are listed in table 1. The catalytic compositions 1 to 4 in this table correspond respectively to the products obtained after impregnating with platinum, according to the process described above, the compounds of examples 1, 2 and 3 according to the invention and comparative example 4.

TABLE 1

NOx

| Composition | 200° C. | 300° C. | 350° C. | 400° C. |
|---|---|---|---|---|
| 1 | 35.8 | 37.9 | 32.1 | 26.6 |
| 2 | 32.6 | 24 | 23.2 | 21.9 |
| 3 | 20.1 | 24.1 | 20.8 | 17.3 |
| 4, comparative | 10.4 | 14.1 | 17.3 | 21 |

It is seen, from the results in table 1, that the compositions of the invention exhibit maximum effectiveness in the temperature region between 200° C. and 350° C., whereas the maximum lies rather toward 400° C. for the comparative composition.

### EXAMPLE 6

This example relates to the regeneration, after sulfation, of the catalytic compositions of example 5.

First of all, the compositions are sulfated by treating them with a gas stream comprising 60 ppm of SO₂ at a temperature of 300° C. for 5 hours.

In order to regenerate the compositions thus sulfated, they are subsequently subjected to treatment with a reducing gas stream based on H₂, CO₂ and H₂O at a temperature of 550° C.

The sulfur content of the sulfated compositions or the compositions after regeneration is determined by programmed temperature reduction (PTR) under a mixture comprising 1% H₂; the composition of the gas phase is monitored by chromatography with a differential detector. The catalyst sample is preoxidized under oxygen before the PTR. The integration of the residual H₂ content at the outlet of the reactor makes it possible to determine the amount of hydrogen consumed in order to reduce the sulfate entities.

By taking into account the stoichiometry for the reduction of the sulfates:

M-SO₄+4H₂→M-S+4H₂O

or M-SO₄+4H₂→M-O+4H₂S

and the hydrogen consumption, the content of S adsorbed during the sulfation and the content of sulfur after the regeneration treatment are calculated.

The level of sulfur adsorbed after the sulfation treatment (1), the level of sulfur adsorbed after the regeneration treatment (2) and the percentage of removal of the sulfur, given by the ratio [(1)−(2)]/(1), are given in the following table 2 for each composition after impregnation of the examples.

TABLE 2

| | % of S | % of S after | % of removal |
|---|---|---|---|
| Composition | adsorbed | regeneration | of the sulfur |
| 1 | 1.3 | 0.16 | 87.7 |
| 2 | 1.9 | 0.21 | 88.9 |
| 3 | 1.1 | 0.06 | 94.5 |
| 4, comparative | 1.9 | 1.1 | 42 |

It is seen that the compositions of the invention exhibit degrees of removal of the sulfur at least twice that of the comparative composition.

In addition, the NOx storage capacities of the products of the various examples after the regeneration treatment are given in the following table 3. The protocol for measuring the NOx storage capacity at 300° C. is identical to that described in example 5.

TABLE 3

| Example | NOx (at 300° C.) |
|---|---|
| 1 | 31.1 |
| 2 | 16.2 |
| 3 | 24.2 |
| 4, comparative | 11 |

1-10. (canceled)

11. A process for the treatment/purification of a gas containing nitrogen oxides (NOx), comprising conveying same through a NOx trap which comprises a composition based on a catalyst for the oxidation of NOx to NO₂ and on a compound based on zirconium oxide and praseodymium oxide in a proportion of praseodymium oxide of from 5% to 50% by weight of oxide.

12. The process as defined by claim 11, said composition comprising a compound of praseodymium oxide in a proportion of from 10% to 40% by weight of oxide.

13. The process as defined by claim 11, said composition comprising a compound which additionally comprises cerium oxide.

14. The process as defined by claim 13, said composition comprising a compound of cerium oxide in a Ce/Zr atomic ratio of from 10/90 to 90/10.

15. The process as defined by claim 11, said oxidation catalyst comprising a precious metal.

16. The process as defined by claim 15, said precious metal comprising platinum.

17. The process as defined by claim 11, conducted on an exhaust gas from an internal combustion engine, of diesel type or of gasoline type operating under lean burn conditions.

18. The process as defined by claim 11, conducted on a gas resulting from the combustion of fuels and having a sulfur content of at least 350 ppm.

19. Apparatus for conducting the process as defined by claim 11, comprising a NOx trap confining a composition which comprises a precious metal and a compound which comprises zirconium oxide and praseodymium oxide in a praseodymium oxide proportion of from 5% to 50% by weight of oxide.

20. The apparatus as defined by claim 19, said composition being confined within a catalytic component included in an exhaust line or a motor vehicle comprising a diesel engine or a lean burn gasoline engine.

21. A composition comprising a precious metal catalyst and a compound which comprises zirconium oxide and praseodymium oxide in a proportion of praseodymium oxide ranging from 5 wt. % to 50 wt. % of oxide.

22. A NOx trap comprising the composition as defined by claim 21.
